(19) United States
(12) Patent Application Publication
(10) Pub. No.: US 2025/0272495 A1
(43) Pub. Date: Aug. 28, 2025

(54) SENTIMENT-BASED ZOOM CONTROL AT A USER INTERFACE

(71) Applicant: The Toronto-Dominion Bank, Toronto (CA)

(72) Inventors: Olivier Hugues Benoit GANDOUET, Montreal (CA); Mouloud-Beallah BELBAHRI, Laval (CA); Yuriy BODJOV, Montreal (CA); Armelle Dominique JÉZÉQUEL, Montreal (CA)

(73) Assignee: The Toronto-Dominion Bank, Toronto (CA)

(21) Appl. No.: 18/934,490

(22) Filed: Nov. 1, 2024

Related U.S. Application Data
(60) Provisional application No. 63/557,207, filed on Feb. 23, 2024.

(51) Int. Cl. G06F 40/30; G06F 3/04842; G06F 9/451

(52) U.S. Cl. CPC G06F 40/30; G06F 3/04842; G06F 9/451

(57) ABSTRACT

In accordance with one aspect of the present disclosure, there is provided a computer-implemented method. The method may include: performing segmentation on text data to generate a number of data segments; providing each of the data segments to a machine learning system; obtaining, as output of the machine learning system, an indication of a sentiment associated with each of the data segments; obtaining an indication of overall sentiment for a plurality of data segments represented by the text data; and providing the indication of the overall sentiment to a device, together with a selectable option to retrieve one or more of the data segments having an indication of sentiment corresponding to the indication of the overall sentiment.

### FIELD

The present application relates to methods and systems for improving efficiency of data retrieval and/or storage of large data sets.

### BACKGROUND

Storing and processing large text-based datasets like call transcripts introduces several computational challenges, primarily due to the sheer volume of data. Transcripts can become enormous when derived from extensive conversations or numerous calls, putting pressure on storage infrastructure. Traditional file systems may struggle to handle these volumes efficiently, leading to the need for more sophisticated storage architectures. Retrieving specific sections of transcripts also becomes time-consuming without proper indexing or search optimization. As data scales, even basic operations like reading or writing to storage can slow down significantly, demanding more efficient file management techniques.

Processing large datasets presents additional challenges, particularly due to the computational load required for natural language processing (NLP) tasks. Extracting meaning from transcripts, such identifying topics, or summarizing conversations, requires significant computational resources. Algorithms must process every word, sentence, and interaction, which, when multiplied by thousands or even millions of calls, can lead to substantial processing time and memory consumption. Techniques like batch processing or distributed computing can help manage the load but introduce their own complexities in terms of synchronization and system overhead.

Furthermore, working with large text datasets demands optimized data handling strategies to ensure that processing workflows are both scalable and efficient. Text processing algorithms, especially those reliant on machine learning or deep learning models, need substantial memory and CPU/GPU power. Handling high-dimensional data such as word embeddings or tokenized sequences for each transcript can quickly overwhelm conventional computing environments. Additionally, ensuring data consistency and handling nuances in language or transcription errors often requires pre-processing steps, adding further to the computational overhead of dealing with large-scale datasets.

In certain cases, such as earnings call transcripts, there is an added layer of urgency that exacerbates the computational challenges. Earnings calls are time-sensitive because they contain critical information that can significantly impact markets. Analysts, investors, and automated trading systems often need to process and analyze these transcripts in near real-time to make decisions quickly. This urgency places immense pressure on computational systems to not only handle the large volume of data but also to parse, analyze, and extract key insights rapidly. Delays in processing could lead to missed opportunities or inaccurate trading decisions, making performance optimization a critical challenge. The need for fast text extraction, sentiment analysis, and summarization under strict time constraints pushes systems to their limits, often requiring parallel processing, real-time data pipelines, and optimized algorithms to ensure that data is processed.

### BRIEF DESCRIPTION OF THE DRAWINGS

Embodiments are described in detail below, with reference to the following drawings:

FIG. 1 is a block diagram of an operating environment for processing large text-based data sets;

FIG. 2 is a further block diagram of an operating environment for processing large text-based data sets;

FIG. 3 is a block diagram of an example computing device in accordance with example embodiments;

FIG. 4 is an example arrangement of memory in accordance with example embodiments;

FIG. 5 is a flowchart of an example method of training a specialized machine learning system for topic classification;

FIG. 6 is a flowchart of an example method of training a specialized machine learning system for topic classification;

FIG. 7 is a flowchart of an example method of using a specialized machine learning system for topic classification;

FIG. 8 is a flowchart of an example method of performing sentiment and topic classification on a data set;

FIG. 9 is a flowchart of an example method of using a specialized machine learning system for sentiment classification;

FIG. 10 is a flowchart of an example method of providing an updated user interface based user input;

FIG. 11 is a flowchart of a method of performing filtering at an interface;

FIG. 12 is an example user interface screen in accordance with example embodiments;

FIG. 13 is an example user interface screen in accordance with example embodiments;

FIG. 14 is an example user interface screen in accordance with example embodiments;

FIG. 15 is an example user interface screen in accordance with example embodiments;

FIG. 16 is an example user interface screen in accordance with example embodiments; and

FIG. 17 is an example training architecture in accordance with example embodiments.

Like reference numerals are used in the drawings to denote like elements and features.

### DETAILED DESCRIPTION OF VARIOUS EMBODIMENTS

In accordance with one aspect of the present disclosure, there is provided a computer-implemented method. The method may include: performing segmentation on text data to generate a number of data segments; providing each of the data segments to a machine learning system; obtaining, as output of the machine learning system, an indication of a sentiment associated with each of the data segments; obtaining an indication of overall sentiment for a plurality of data segments represented by the text data; and providing the indication of the overall sentiment to a device, together with a selectable option to retrieve one or more of the data segments having an indication of sentiment corresponding to the indication of the overall sentiment.

In some implementations, obtaining an indication of overall sentiment for the plurality of data segments represented by the text data includes: providing the plurality of data segments represented by the text data to the machine learning system; and obtaining, as output of the machine learning system, an indication of a sentiment associated with the plurality of data segments represented by the text data.

In some implementations, the data segments may represent sentences.

In some implementations, the method may further include: receiving a selection of the selectable option to retrieve the one or more data segments having the indication of sentiment corresponding to the indication of the overall sentiment; in response to receiving the selection of the selectable option, retrieving the data segments having an indication of sentiment corresponding to the indication of the overall sentiment; and providing one or more of the retrieved data segments to the device.

In some implementations, the one or more of the retrieved data segments may be provided on a user interface of the device and wherein the user interface includes a selectable option to filter the retrieved data segments based on a topic. The method may further include: receiving via the selectable option to filter the retrieved data segments based on a topic, a filter parameter representing one or more topics; and in response to receiving the filter parameter, filtering the retrieved data segments based on the filter parameter and updating the user interface.

In some implementations, the method may further include: providing at the device, a selectable option to retrieve one or more of the data segments having an indication of sentiment contrary to the indication of the overall sentiment; receiving a selection of the selectable option to retrieve the one or more data segments having the indication of sentiment contrary to the indication of the overall sentiment; in response to receiving the selection of the selectable option, retrieving the data segments having an indication of sentiment contrary to the indication of the overall sentiment; and providing one or more of the retrieved data segments to the device.

In some implementations, the text data may be a transcript of a call.

In some implementations, the text data may be a transcript of a transcript of a presentation.

In some implementations, the indication of overall sentiment may indicate one of: a positive overall sentiment, a negative overall sentiment, and a neutral overall sentiment.

In some implementations, the plurality of data segments represented by the text data form all of the text data.

In some implementations, the plurality of data segments represented by the text data may be a subset of all of the number of data segments obtained through the segmentation.

In some implementations, the indication of overall sentiment may be a summary of an overall sentiment and wherein the summary is a predefined maximum length.

In another aspect, there is provided a computer system. The computer system may include a processor. The computer system may include a communications module coupled to the processor. The computer system may include a memory coupled to the processor. The memory may store instructions that, when executed, configure the processor to perform a method described herein. For example, the instructions may configure the processor to: perform segmentation on text data to generate a number of data segments; provide each of the data segments to a machine learning system; obtain, as output of the machine learning system, an indication of a sentiment associated with each of the data segments; obtain an indication of overall sentiment for a plurality of data segments represented by the text data; and provide the indication of the overall sentiment to a device, together with a selectable option to retrieve one or more of the data segments having an indication of sentiment corresponding to the indication of the overall sentiment.

In yet another aspect, there is provided a non-transitory computer readable medium. The computer readable medium may store instructions that, when executed, configure a computing system to perform a method described herein.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

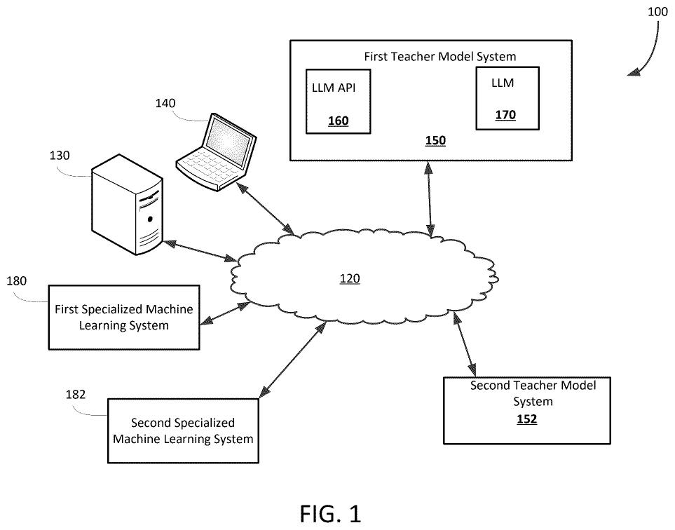

FIG. 1 illustrates an example computing environment 100 consistent with certain disclosed embodiments. As shown in FIG. 1, the computing environment 100 may include a first computing system 130, a client device 140, a first teacher model system 150, a second teacher model system 152, a first specialized machine learning system 180, a second specialized machine learning system 182 and a communications network 120 connecting one or more of the components of computing environment 100. The communications network 120 may include one or more wired or wireless networks, including the Internet.

The first teacher model system 150 may be a collection of computing resources. For example, the first teacher model system 150 may include a server. In at least some implementations, the first teacher model system 150 may be managed by a cloud service provider. Examples of cloud service providers include Amazon Web Services (AWS), Microsoft Azure, and Google Cloud Platform (GCP), for example. The first teacher model system 150 may, in at least some implementations, include data centers located in various remote locations. Each data center may include multiple physical servers.

The first teacher model system 150 is a machine learning system. In at least some implementations, the first teacher model system 150 may include a large language model (LLM) 170. The LLM 170 is a type of artificial intelligence (AI) model designed to understand and generate natural-language input, including human-like text. The LLM 170 may be trained on extensive datasets containing a wide range of text from sources such as the internet, books, articles, and other sources to learn the patterns, structures, and nuances of language. In this way, the LLM 170 may comprehend natural-language input, including human-like text, and generate appropriate responses.

The LLM 170 may be configured to perform a variety of language-related tasks, such as text generation, translation, summarization, question answering, etc. In this way, the LLM 170 may generate coherent and contextually relevant responses to text prompts.

The LLM 170 may be, for example, one of the OpenAPI™ Generative Pre-trained Transformer (GPT) series, such as GPT-1, GPT-2, GPT-3, and GPT-4. Alternatively, the LLM 170 may be a Bidirectional Encoder Representations from Transformers (BERT), a Text-To-Text Transfer Transformer (T5), an XLNet™, Robustly Optimized BERT Approach (ROBERTa), or a Turing-Natural Language Generation (Turing-NLG). The LLM 170 may be of other types in other implementations.

In at least some implementations, the first teacher model system 150 may include an LLM API 160. The LLM API 160 is an interface configured to provide access to the LLM 170. The LLM API 160 may be, for example, an OpenAPI™ GPT API, a Google™ Cloud Natural Language API, a Microsoft Azure™ Cognitive Services API, or a Hugging Face™ Transformers API, for example.

The first computing system 130, client device 140, first teacher model system 150, second teacher model system 152, first specialized machine learning system 180, and/or second specialized machine learning system 182 may be computer systems and/or may be provided on, in or by computer systems. Computer systems may be, for example, a mainframe computer, a minicomputer, or the like. Computer systems may include one or more computing devices. For example, a computer system may include multiple computing devices such as, for example, database servers, computer servers, and the like. The multiple computing devices may be in communication using a computer network. For example, computing devices may communicate using a local-area network (LAN). In some embodiments, computer systems may include multiple computing devices organized in a tiered arrangement. For example, a computer system may include middle-tier and back-end computing devices. In some embodiments, a computer system may be a cluster formed of a plurality of interoperating computing devices.

The first computing system 130, client device 140, first teacher model system 150, second teacher model system 152, first specialized machine learning system 180, and/or second specialized machine learning system 182 may be a single server, multiple servers, a server farm, or any other such arrangement of computing devices to implement the associated computing functionality.

The second teacher model system 152 may be of the same type as the first teacher model system 150. For example, while not shown, the second teacher model may be or include an LLM such as an LLM of the type described with reference to the LLM 170 of the first teacher model system 150. In some implementations, the second teacher model system 152 may include an LLM API, such as the LLM API 160 described with reference to the first teacher model system 150.

In other implementations, the second teacher model system 152 may be of a different type than the first teacher model system 150. For example, the second teacher model system 152 may be a sentiment analysis model system. By way of example, the second teacher model system 152 may be a finBERT system. FinBERT is a domain-specific natural language processing (NLP) model that leverages the BERT (Bidirectional Encoder Representations from Transformers) architecture to perform financial sentiment analysis. BERT is a transformer-based model that utilizes a bi-directional attention mechanism, allowing it to capture contextual relationships in text more effectively than earlier models.

The finBERT model retains the foundational architecture of BERT, which consists of multiple layers of transformer blocks. Each layer incorporates self-attention mechanisms that enable the model to weigh the significance of different words in a sentence, considering their context both before and after each word.

FinBERT is fine-tuned on a substantial corpus of financial texts, including earnings reports, news articles, and analyst commentaries. This specialized training dataset allows it to learn financial terminology, jargon, and context-specific sentiment cues, enhancing its ability to discern subtle sentiment shifts in financial language. The model may be trained for three-class sentiment classification: positive, negative, and neutral. During inference, it processes financial text input and outputs a probability distribution across these sentiment classes, enabling users to quantify market sentiment.

The first teacher model system 150 may be used, by the first computer system 130, to assist with training the first specialized machine learning system 180 and the second teacher model system 152 may be used, by the first computer system 130, to assist with training the second specialized machine learning system 182.

In some implementations, there may be only one teacher model system and the first teacher model system 150 may provide the functions of both the first teacher model system 150 and the second teacher model system 152. For example, the first teacher model system 150 may be used to assist with training the first specialized machine learning system 180 and to assist with training the second specialized machine learning system 182.

The first specialized machine learning system 180 is a machine learning system that is trained to output a topic that represents a data segment, such as a sentence. The sentence may be a sentence extracted from a transcript of an event. The event may be a specific category of event. That is, the data segment may be extracted from a document that represents a specific type of event, such as an earnings call, a news event, a sporting event, etc.

The topic may be, for example, a category of the data segment. In some implementations, the topic may be of a maximum length of one word. In some implementations, the topic may be of a maximum length of two words. In some implementations, the topic may have a larger maximum length. In some implementations, the topic may not have a maximum length.

Where the first specialized machine learning system 180 is configured to output a topic for financial events such as earnings calls, the topic that is output by the first specialized machine learning system 180 based on an inputted data segment, may be a financial topic. By way of example, example topics may include: revenue, earnings per share (EPS), gross margin, operating margin, cost of goods sold, operating expenses, guidance, financial performance, cash flow from operations, capital expenditures, dept levels and financing, balance sheet metrics, dividends and buybacks, cost management and efficiency, mergers and acquisitions, strategic initiatives, management changes, workforce, product/service updates, innovation and R&D, industry trends, market share and competition, customer acquisitions, economic factors, foreign exchange, geographic performance, regulatory changes, risk factors, environmental, social and governance, or other topics.

The topics may be of other types in other implementations and may be non-financial topics in other implementations. Where the first specialized machine learning system 180 is configured to output a topic for sporting events, such as a sentence extracted from announcer commentary of the sporting event, the topic that is output by the first specialized machine learning system 180 based on an inputted data segment, may be a sporting topic. For example, the topics may be or include topics such as: penalties, goals, timeouts, line changes, etc.

Where the first specialized machine learning system 180 is configured to output a topic for news events, such as a sentence extracted from a transcript of a radio or television news program, the topic that is output by the first specialized machine learning system 180 based on an inputted data segment, may be a news topic. For example, such topics may include: crime, politics, sports, weather, etc.

Other example topics may be used in other implementations.

The second specialized machine learning system 182 is a machine learning system that is trained to output a sentiment represented by text data, such as a data segment, such as a sentence. The sentence may be a sentence extracted from a transcript of an event, which may be an event of the type described above. The second specialized machine learning system 182 may be trained to output a sentiment indicator. The sentiment indicator may be an indicator selected from a sentiment indicator set. The sentiment indicator set may include, for example, positive and/or negative. In some implementations, the sentiment indicator set may include neutral. For example, the sentiment indicator set may, in some implementations, be a three state or three class set.

The first computer system 130 may be configured to perform one or more functions as described herein. For example, the first computer system 130 may be configured to generate a training data set for training the first specialized machine learning system 180. The first computer system 130 may interact with the first teacher model system 150 to generate the training data set.

The first computer system 130 may, additionally or alternatively, be configured to be configured to generate a further training data set for training the second specialized machine learning system 182. The first computer system 130 may interact with the first teacher model system to generate the further training data set.

The first computer system 130 may also train one or both of the first and second specialized machine learning systems 180, 182 using such training data set(s).

After the first and/or second specialized machine learning systems 180, 182 are trained, the first computer system 130 may provide a further data segment to the first and/or second specialized machine learning systems 180, 182 to obtain a topic (from the first specialized machine learning system 180) and/or a sentiment (from the second specialized machine learning system 182).

The first computer system 130 may associate the obtained topic and/or sentiment with the further data segment and may obtain such topics and/or sentiments for all data segments contained in a larger piece of text, which may be referred to as text data. For example, the text data may be a transcript and the first computer system 130 may obtain a topic and/or sentiment for each sentence in the transcript, and may associate each sentence with its obtained topic and sentiment.

The first computer system 130 may use such sentiment and/or topic data to allow for rapid retrieval and display of such data on a user interface. For example, the first computer system 130 may use such data to provide a user interface to a device, such as a client device 140, for interacting with and/or manipulating such data.

The techniques described herein may allow for rapid retrieval and display and allow for the computing operations to be performed by a system that has little computing power. For example, one or both of the first and second specialized machine learning systems 180, 182 may be lightweight machine learning systems that require less computing power than the first teacher model system 150 and/or the second teacher model system 152.

In some embodiments, the first computer system 130 may include a speech recognition module which may convert a received audio or video file to text-based data.

In some embodiments, the first computer system 130 may include one or more prompt engine modules. The one or more prompt engine modules may be configured to generate and send prompts to an LLM API 160.

The first computer system 130 may communicate with a client device 140. The client device 140 may take a variety of forms such as a smartphone, a tablet computer, a wearable computer such as a head-mounted display or smartwatch, a laptop or desktop computer, or a computing device of another type. The client device 140 may also be referred to as an electronic device.

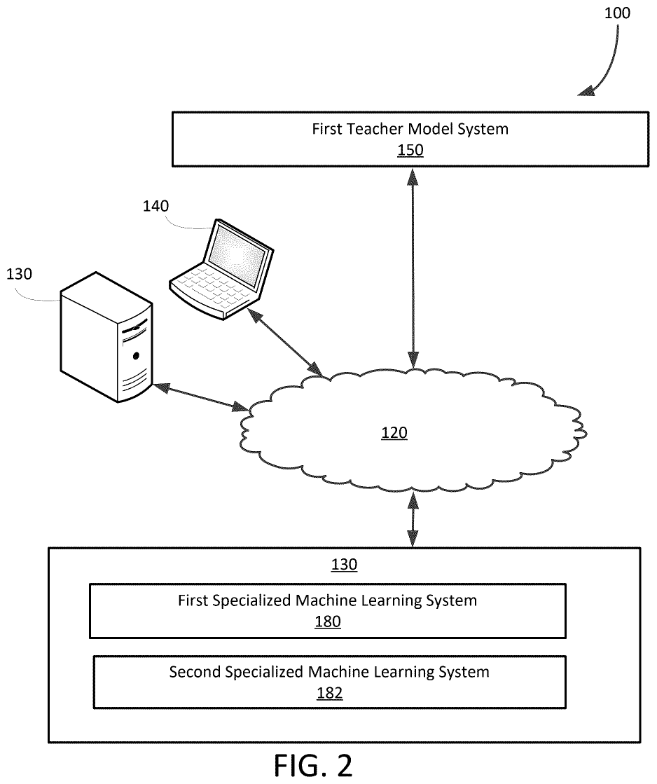

The computing environment 100 may take other forms apart from the arrangement of systems illustrated in FIG. 1. For example, two or more of the first teacher model system 150, second teacher model system 152, first specialized machine learning system 180, second specialized machine learning system 182 and first computer system 130 may be implemented on a common system. By way of example, in one implementation, illustrated in FIG. 2, the first specialized machine learning system 180 and the second specialized machine learning system 182 are implemented on the first computer system 130. In the illustrated example, there is only one teacher model system, the first teacher model system 150. This system may provide the functions of both the first and second teacher model systems described herein.

Other architectures are also possible.

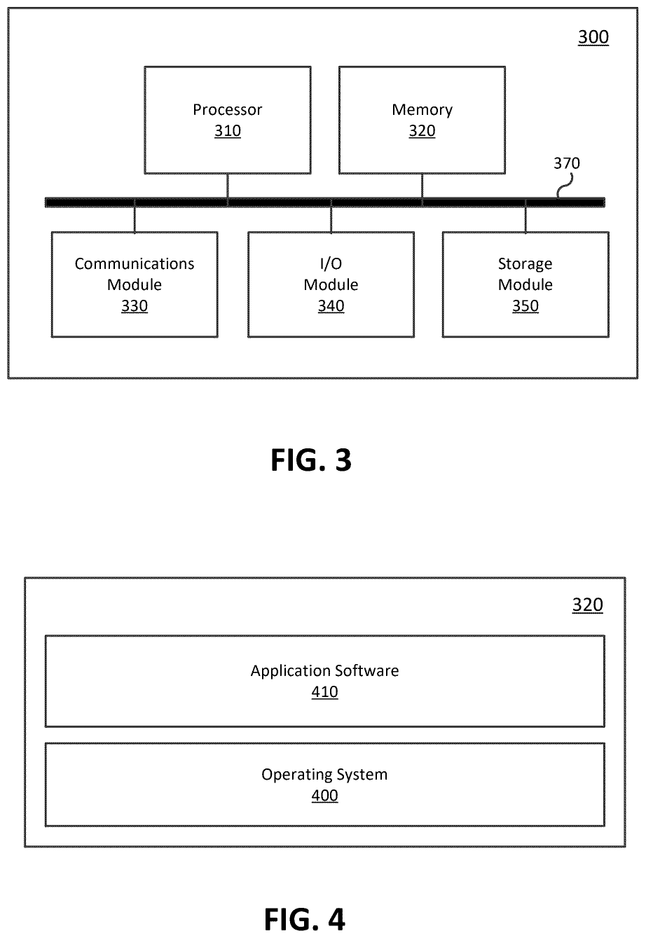

FIG. 3 is a simplified schematic diagram showing components of an exemplary computing device 300.

The first computing system 130, client device 140, first teacher model system 150, second teacher model system 152, first specialized machine learning system 180, and/or second specialized machine learning system 182 may be of the same type as the computing device 300.

The computing device 300 includes a variety of modules. For example, as illustrated, the example computing device 300 may include a processor 310, a memory 320, a communications module 330, an Input/Output (I/O) module 340, and/or a storage module 350. As illustrated, the foregoing example modules of the example computing device 300 are in communication over a bus 370. As such, the bus 370 may be considered to couple the various modules of the computing device 300 to each other, including, for example, to the processor 310.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the computing device 300.

The communications module 330 allows the computing device 300 to communicate with various communications networks and/or other computing devices. For example, the communications module 330 may allow the computing device 300 to send or receive communications signals. Communications signals may be sent or received according to one or more protocols or according to one or more standards. The communications module 330 may allow the computing device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE), 5G or the like. Additionally or alternatively, the communications module 330 may allow the computing device 300 to communicate using near-field communication (NFC), via Wi-Fi™, using Bluetooth™ or via some combination of one or more networks or protocols. In some embodiments, all or a portion of the communications module 330 may be integrated into a component of the computing device 300. For example, the communications module 330 may be integrated into communications circuitry, such as a communications chipset.

The I/O module 340 is an input/output module. The I/O module 340 allows the computing device 300 to receive input from and/or to provide input to components of the computing device 300 such as, for example, various input modules and output modules. For example, the I/O module 340 may allow the computing device 300 to receive input from and/or provide output to a display (not shown).

The storage module 350 allows data to be stored and retrieved. In some embodiments, the storage module 350 may be formed as a part of the memory 320 and/or may be used to access all or a portion of the memory 320. Additionally or alternatively, the storage module 350 may be used to store and retrieve data from persisted storage other than the persisted storage (if any) accessible via the memory 320. In some embodiments, the storage module 350 may be used to store and retrieve data in/from a database. A database may be stored in persisted storage. Additionally or alternatively, the storage module 350 may access data stored remotely such as, for example, as may be accessed using a local area network (LAN), wide area network (WAN), personal area network (PAN), and/or a storage area network (SAN). In some embodiments, the storage module 350 may access data stored remotely using the communications module 330. In some embodiments, the storage module 350 may be omitted and its function may be performed by the memory 320 and/or by the processor 310 in concert with the communications module 330 such as, for example, if data is stored remotely.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the computing device 300. As illustrated, these software components include an operating system 400 and an application software 410.

The operating system 400 is software. The operating system 400 allows the application software 410 to access the processor 310 (FIG. 3), the memory 320, the communications module 330, the I/O module 340, and the storage module 350 of the computing device 300. The operating system 400 may be, for example, Google™ Android™, Apple™ iOS™, UNIX™, Linux™, Microsoft™ Windows™, Apple OSX™ or the like.

The application software 410 adapts the computing device 300, in combination with the operating system 400, to operate as one ore more of the first computing system 130, client device 140, first teacher model system 150, second teacher model system 152, first specialized machine learning system 180, and/or second specialized machine learning system 182.

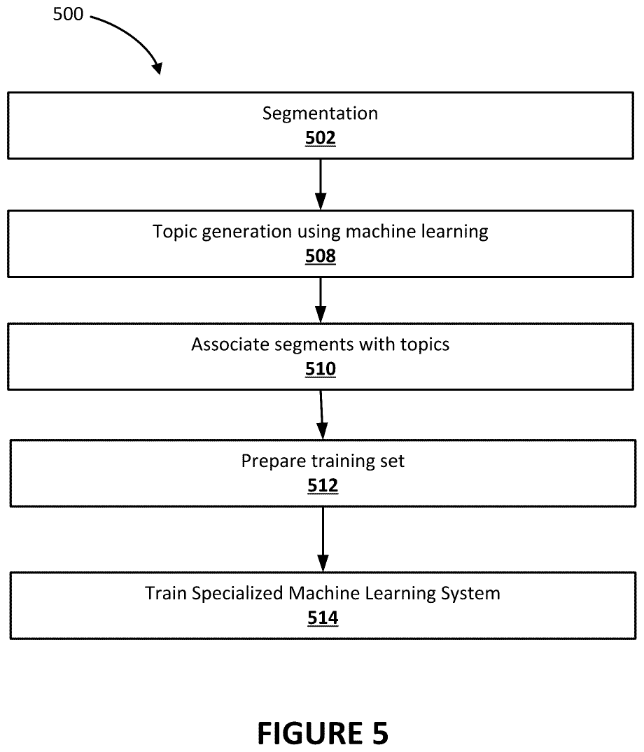

Reference is now made to FIG. 5, which shows, in flowchart form, an example method 500 of training a specialized machine learning system. For example, the method 500 may be performed to train the first specialized machine learning system 180 as a lightweight topic classifier. The method 500 may be implemented by a computing system, such as the first computing system 130 (FIGS. 1 and 2). For example, a software module may be configured to cause the first computing system 130 of FIG. 1 to implement the method 500. The method 500 may be performed, for example, by the processor 310 (FIG. 3) of a computer device 300 executing software comprising instructions such as may be stored in the memory 320 of the computer device 300. More particularly, processor-executable instructions may, when executed, configure a processor 310 of a computing system such as the first computing system 130 to perform all or parts of the method 500 or a portion thereof.

In performing the method 500, the first computing system 130 may cooperate with other systems and devices such as, for example, the client device 140, the first teacher model system 150, the second teacher model system 152, the first specialized machine learning system 180 and/or the second specialized machine learning system 182. Each of these devices may be configured with processor-executable instructions which cause such devices to perform methods which cooperate with the method 500. Accordingly, operations that are referred to below as being performed by the client device 140 may be included in a method which a processor of the client device 140 may perform. Similarly, operations that are referred to below as being performed by the first computing system 130 may be included in a method which a processor of the first computing system 130 may perform. Similarly, operations that are referred to below as being performed by the first teacher model system 150 may be included in a method which a processor of the first teacher model system 150 may perform. Similarly, operations that are referred to below as being performed by the second teacher model system 152 may be included in a method which a processor of the second teacher model system 152 may perform. Similarly, operations that are referred to below as being performed by the first specialized machine learning system 180 may be included in a method which a processor of the first specialized machine learning system 180 may perform. Similarly, operations that are referred to below as being performed by the second specialized machine learning system 182 may be included in a method which a processor of the second specialized machine learning system 182 may perform.

Further, at least some operations described as being performed by one system may be performed by a different system.

The method 500 may be performed, in at least some implementations, to construct a topic classification model. As will be described below, a heavy weight machine learning model, such as may be provided by the first teacher model system 150, may be used to train a lightweight machine learning model, such as first specialized machine learning model 180.

The first computing system 130 may perform a plurality of operations in order to generate a training data set, which may also be referred to as a training set. For example, the first computing system 130 may execute operations 502 through 512 to generate and/or produce the training data set. First, at an operation 502, the first computing system 130 may perform segmentation on text data to generate a number of data segments. The text data may be unstructured data. The text data may be of a particular type or category. The text data may be a transcript, or a portion of a transcript of an event of a particular type. The type of the event that is represented by the text data will depend on the type of data that the first specialized machine learning system 180 is configured to receive as an input and trained to analyze. For example, in one implementation, the text data may be a transcript of a call, such as an earnings call. In such an example, the method 500 may train the first specialized machine learning system 180 to identify topics represented in similar transcripts. In another example, the text data may be a transcript of a sporting event, such as a transcript of a broadcast of the sports event. In such an example, the method 500 may train the first specialized machine learning system 180 to identify topics represented in similar transcripts. Other type of text data may be used in other implementations. Notably, the text data that is used at the operation 502 is of a predetermined type; it is not simply any random text data.

The segmentation of the text data at the operation 502 may separate the text data into data segments. The data segments may, for example, be referred to a chunks, text chunks or text segments. The data segments may, in at least some implementations, represent text parts. For example, each data segment may be a separate sentence in some implementations. The segmentation may be performed, for example, by identifying one or more delimiters, such as punctuation marks, which separate one sentence from another.

After data segments have been generated/extracted, they may be used to generate a list of topics that are represented by such data segments. The list of topics may be generated using machine learning. More specifically, the list of topics may be generated using a machine learning model, such as the first teacher model system 150. For example, at an operation 508, the first computing system 130 may provide at least a subset of the data segments obtained during the segmentation to a machine learning system, such as the first teacher model system 150. For example, the data segments may be provided as an input to the first teacher model system 150. For example, the data segments may be provided as an input file for the first teacher model system 150. The first computing system 130 may also provide one or more instructions to the machine learning system to cause the machine learning system to identify a set of topics that describe such data segments. This set of topics may be referred to as a topic set. By way of example, the first computing system 130 may provide one or more prompts to the first teacher model system 150 which causes the first teacher model system 150 to identify and output one or more topics represented by the data segments that were provided as input to the first teacher model system 150. By way of example, the prompt may be “Can you provide financial topics that describe the following sentences using a general classification?” In at least some implementations, the prompt may indicate a desired format of any output. For example, the prompt may be “Can you provide financial topics that describe the following sentences using a general classification? Format your answer by separating all the detected topics with semi-colons.”

In at least some implementations, the first computing system 130 may, at the operation 508 provide multiple instructions and/or multiple prompts to the first teacher model system 150. By way of example, it may be that a first prompt requests topics to be identified and then a second prompt requests that the identified topics be formatted in a specific way.

After topics have been generated by the first teacher model system 150, the first computing system 130 may create a labelled dataset of data segments. For example, the first computing system 130 may create a labelled dataset of sentences. Each sentence in this dataset may be associated with a topic that represents that sentence. For example, at an operation 510, the first computing system 150 may associate each data segment of a plurality of data segments with a respective topic. For example, the first computing system 130 may associate each of a plurality of data segments with one of the topics in the topic set.

The operation 510 may, for example, be performed as follows. The first computing system 130 may obtain a plurality of data segments; for example, sentences. These may be the same sentences using in the topic generation operation 508, or they may be different sentences. For example, in one implementation, the first computing system 130 randomly selects a predetermined number of sentences from text data, such as from text data. The text data may be text data of a similar type as the text data used in the operation 502. That is, the text data that is used for creating the labelled dataset may be of a common type as the text data used to generate the topics. By way of example, the text data used at the operation 510 may be a transcript, or a portion of a transcript of an event of a particular type.

The first computing system 130 then provides at least a portion of the set of topics that were identified at the operation 508 to a machine learning system, such as the first teacher model system 150. The first computing system 130 may also provide one or more instructions to the machine learning system to cause the machine learning system to classify the plurality of data segments using the at least a portion of the set of topics. By way of example, the first computing system may provide a prompt, such as the following, to the first teacher model system 150: “Considering the following list of topics: [list of topics], could you provide a classification on the following sentences topics? Please format your answer in the following way: Topic: Topic identified.” As noted above, the first computing system 130 may provide formatting instructions to the machine learning system.

In testing, it has been found that creating a labelled dataset of approximately 80,000 sentences is suitable.

The machine learning system, such as the first teacher model system 150, generates an output in response to the prompt. The output associates one or more of the data segments that were input to the machine learning system with one or more of the topics that were input to the machine learning system.

The first computing system 130 then, at an operation 512, prepares training data based on the output of the machine learning system. That is, the first computing system 130 uses the output of the machine learning system to create a dataset in which each data segment provided to the machine learning system at the operation 510 is associated with a particular one of the topics in the topic set generated at the operation 508. This training data, which may be referred to as a labelled dataset or a training data set, may be stored in memory.

After the training data has been obtained, the training data may be used by the first computing system 130, at an operation 514, to train a specialized machine learning system, such as the first specialized machine learning system 180 (FIG. 1 and FIG. 2). More specifically, the first computing system 130 may train the first specialized machine learning system 180 using the training data set to configure the first specialized machine learning system 180 to detect one or more topics represented in one or more further data segments. The first specialized machine learning system 180 is a lightweight machine learning system that requires less computing capabilities than the machine learning system i.e., than the first teacher model system 150.

In at least some implementations, to create a lightweight version topic classification model, an MPNet architecture may be used. MPNet, or Masked and Permuted Network, is an advanced transformer-based architecture designed for natural language processing tasks. It integrates the strengths of previous models like BERT and XLNet to improve efficiency and effectiveness during the pre-training phase. MPNet utilizes both masked language modeling and permuted language modeling.

In the masked language modeling aspect, MPNet may randomly masks certain tokens in an input sequence and trains the model to predict these masked tokens based on the surrounding context. This approach may help the model learn rich contextual representations. Unlike BERT, which processes the input in a fixed order, MPNet introduces permutation-based language modeling. This allows the model to learn from multiple possible arrangements of the tokens, enabling it to capture dependencies and relationships that may not be evident in a linear sequence.

This permutation mechanism enhances the model's ability to understand context by exposing it to various combinations of input orders, thereby enriching the training process. By blending these two approaches, MPNet efficiently leverages the benefits of both masking and permutation, leading to more robust language representations.

MPNet may also employ activation functions like ReLU (Rectified Linear Unit) within its architecture. ReLU helps introduce non-linearity into the model, which may help when learning complex patterns in the data. It typically operates by outputting the input directly if it is positive; otherwise, it returns zero. This behavior allows the model to maintain important information while suppressing less relevant signals, contributing to better performance in various Natural Language Processing (NLP) tasks.

The architecture of MPNet is designed to be bidirectional, meaning it can attend to both left and right contexts simultaneously. This is helpful for understanding the nuances of language, as words often depend on their surrounding words for meaning.

A multilayer perceptron (MLP) may be added to the output of the MPNet model. A multilayer perceptron (MLP) is a type of artificial neural network that consists of multiple layers of nodes or neurons. The MLP may have three types of layers: an input layer, one or more hidden layers, and an output layer. The input layer receives the initial data, which can be features from a dataset. Each neuron in this layer sends its output to the neurons in the first hidden layer.

The hidden layers may be where the actual learning occurs. Each neuron in a hidden layer may receive inputs from the previous layer, applies a weighted sum, adds a bias, and then passes the result through an activation function, such as the sigmoid function or ReLU (Rectified Linear Unit). The activation function may introduce non-linearity, allowing the network to learn complex patterns in the data.

The output layer provides a final prediction. The output layer might use a softmax function to produce probabilities for different classes.

The MLP architecture may be determined through a random search within a parameter space. For each layer, ReLU activation may be applied. To control for overfitting, a dropout may be used at different rates. Furthermore, considering the non-linearity of ReLU, batch normalization may be incorporated in all layers to account for this effect. To establish a search space that promotes convergence, initial tests may be performed on a dataset, for example, specifically investigating the batch size and the learning rate.

The search space for various hyperparameters may include one or more of the following:
Hidden Layers: {1, 2, 3, 4}
First Layer Size: {1024, 768, 512, 256, 128}
Dropout Rate {0, 0.4, 0.7}
With Batch Norm {True, False}
Layer Ratio {0.5, 1}
Learning Rate {0.00005, 0.0001, 0.0002, 0.0004, 0.0008, 0.001}
Batch Size {64, 128, 256, 512}

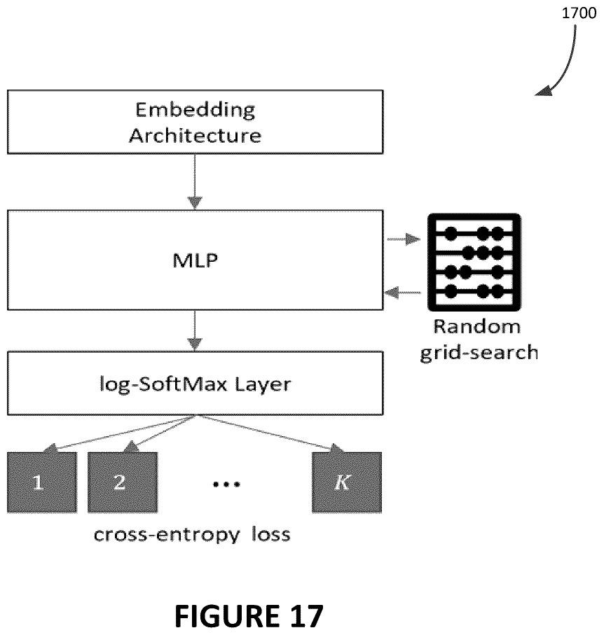

Referring briefly to FIG. 17, an example training architecture 1700 is illustrated. The example training architecture may be used at the operation 514 of the method 500 of FIG. 5 to train the first specialized machine learning system.

Accordingly, at the operation 514, the first computing system 130 may train the specialized machine learning system using the training data set by training the specialized machine learning system using MPNet. Further, at the operation 514, the first computing system 130 may train the specialized machine learning system using the training data set by using Rectified Linear Unit (ReLU). At the operation 514, the first computing system 130 may train the specialized machine learning system using the training data set by using batch normalization in all layers to account for non-linearity of ReLU. At the operation 514, the first computing system 130 may train the specialized machine learning system using the training data set by training the specialized machine learning system using multilayer perceptron (MLP) for the output of an MPNet model.

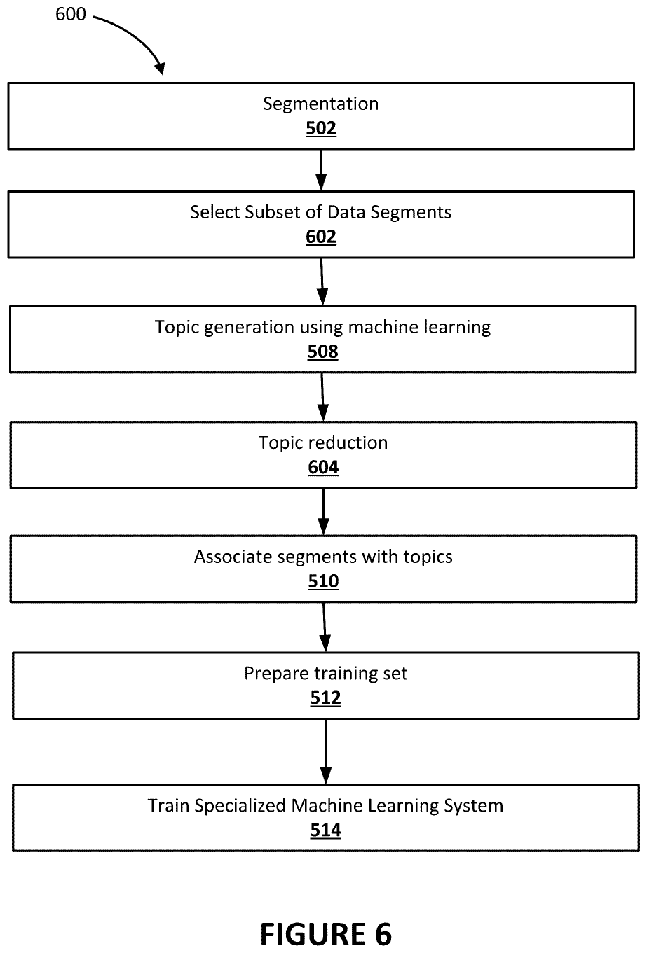

The method 600 may be modified. For example, some example modifications will now be described with reference to FIG. 6. FIG. 6 shows, in flowchart form, an example method 600 of training a specialized machine learning system. For example, the method 600 may be performed to train the first specialized machine learning system 180. The method 600 may be implemented by a computing system, such as the first computing system 130 (FIGS. 1 and 2). For example, a software module may be configured to cause the first computing system 130 of FIG. 1 to implement the method 600. The method 600 may be performed, for example, by the processor 310 (FIG. 3) of a computer device 300 executing software comprising instructions such as may be stored in the memory 320 of the computer device 300. More particularly, processor-executable instructions may, when executed, configure a processor 310 of a computing system such as the first computing system 130 to perform all or parts of the method 600 or a portion thereof.

In performing the method 600, the first computing system 130 may cooperate with other systems and devices such as, for example, the client device 140, the first teacher model system 150, the second teacher model system 152, the first specialized machine learning system 180 and/or the second specialized machine learning system 182. Each of these devices may be configured with processor-executable instructions which cause such devices to perform methods which cooperate with the method 600. Accordingly, operations that are referred to below as being performed by the client device 140 may be included in a method which a processor of the client device 140 may perform. Similarly, operations that are referred to below as being performed by the first computing system 130 may be included in a method which a processor of the first computing system 130 may perform. Similarly, operations that are referred to below as being performed by the first teacher model system 150 may be included in a method which a processor of the first teacher model system 150 may perform. Similarly, operations that are referred to below as being performed by the second teacher model system 152 may be included in a method which a processor of the second teacher model system 152 may perform. Similarly, operations that are referred to below as being performed by the first specialized machine learning system 180 may be included in a method which a processor of the first specialized machine learning system 180 may perform. Similarly, operations that are referred to below as being performed by the second specialized machine learning system 182 may be included in a method which a processor of the second specialized machine learning system 182 may perform.

Further, at least some operations described as being performed by one system may be performed by a different system.

The method 600 may be performed, in at least some implementations, to construct a topic classification model. As will be described below, a heavy weight machine learning model, such as may be provided by the first teacher model system 150, may be used to train a lightweight machine learning model, such as first specialized machine learning model 180

The method 600 includes a number of operations in common with the method 500 of FIG. 5 and such operations may not be discussed in detail. For example, one or more of the operations 502, 508, 510, 512 and 514 of the method 500 of FIG. 5 may be performed during the method 600 of FIG. 6.

The first computing system 130 may, at an operation 502, perform segmentation as described above with reference to FIG. 5.

The first computing system 130, at an operation 602, may select a subset of the data segments. For example, the first computing system 130 may randomly select a defined number of the data segments. This step may aid in reducing the computational complexity of the operation 508, which may then be performed as described above with reference to FIG. 5. More specifically, at the operation 508 in the method 600, only the selected data segments are used. Some of the data segments in the original data set are dropped at the operation 602 and this may allow for computing efficiencies. That is, at the operation 602, the first computing system 130 may provide the selected subset of the data segments and may exclude data segments that are not included in the selected subset.

In some implementations, the method 600 may include an operation 604 in which topic reduction is performed. Topic reduction may help to realize processing efficiencies in subsequent operations. There are various alternative topic reduction operations that might be performed at the operation 604. By way of example, the first computing system 130 may perform topic reduction using the first teacher model system 150. For example, the first computing system 130 may instruct the first teacher model system 150 to eliminate any redundancies in the topic set. Additionally or alternatively, the first computing system 130 may instruct the first teacher model system 150 to reduce the size of the topic set by selecting only meaningful topics for a particular text data type.

Another way to perform topic reduction is by filtering topics based on a pre-defined threshold. For example, let K be the number of suggested topics and nk be the number of sentences from the sample Sal that were classified as the kth topic, k=1, . . . , K. The idea is to keep the most frequent topics (in terms of nk) allowing the classification of a total number of sentences greater than the pre-defined threshold.

A further approach to topic reduction that may be employed at the operation 604 is by using sentence embedding. This approach involves employing a pre-trained sentence embedding model to convert the list of outputted topics into vectors. The vectors can then be fed to the k-means algorithm, which clusters the topics, resulting in a reduced final number of topics. Finally, an alternative approach is to seek expert opinion.

Further, in some implementations, topic reduction could be employed based on input received via an input device. For example, a user may review the topic set and may eliminate some topics by interacting with the first computing system 130 via the input device.

After topic reduction, the operations 510, 512 and 514 may be performed as described above with reference to FIG. 5.

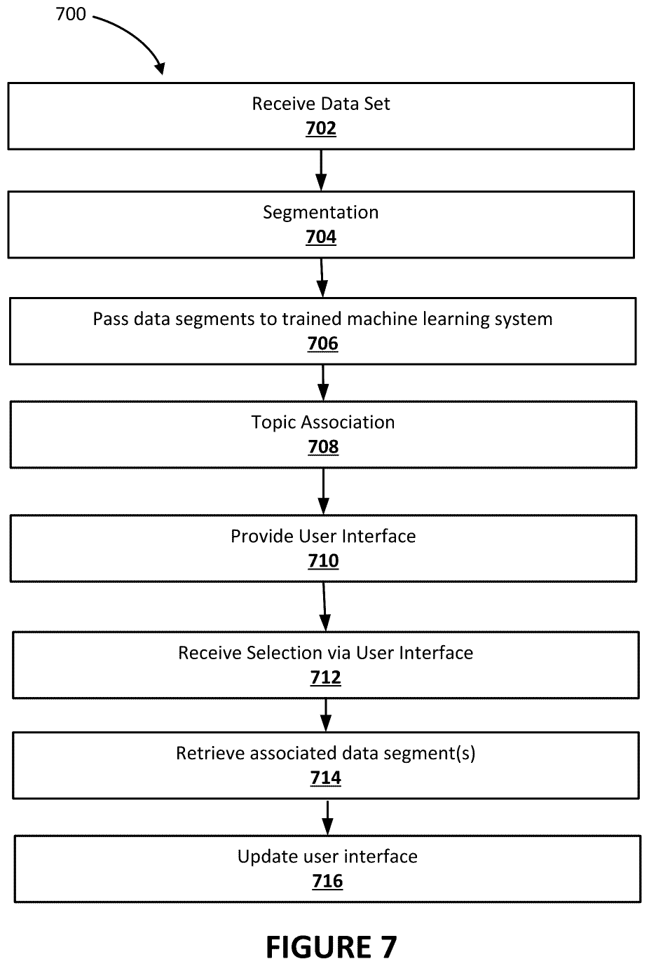

After the first specialized machine learning system 180 has been trained using the techniques described above with reference to FIGS. 5 and 6, it may be used to identify topics contained in data that is similar to the data that it was trained on. For example, reference is now made to FIG. 7, which shows, in flowchart form, an example method 700 of identifying topics in text data using a specialized machine learning system. For example, the method 700 may be performed after training the first specialized machine learning system 180. The method 700 may be implemented by a computing system, such as the first computing system 130 (FIGS. 1 and 2). For example, a software module may be configured to cause the first computing system 130 of FIG. 1 to implement the method 700. The method 700 may be performed, for example, by the processor 310 (FIG. 3) of a computer device 300 executing software comprising instructions such as may be stored in the memory 320 of the computer device 300. More particularly, processor-executable instructions may, when executed, configure a processor 310 of a computing system such as the first computing system 130 to perform all or parts of the method 700 or a portion thereof.

In performing the method 700, the first computing system 130 may cooperate with other systems and devices such as, for example, the client device 140, the first teacher model system 150, the second teacher model system 152, the first specialized machine learning system 180 and/or the second specialized machine learning system 182. Each of these devices may be configured with processor-executable instructions which cause such devices to perform methods which cooperate with the method 700. Accordingly, operations that are referred to below as being performed by the client device 140 may be included in a method which a processor of the client device 140 may perform. Similarly, operations that are referred to below as being performed by the first computing system 130 may be included in a method which a processor of the first computing system 130 may perform. Similarly, operations that are referred to below as being performed by the first teacher model system 150 may be included in a method which a processor of the first teacher model system 150 may perform. Similarly, operations that are referred to below as being performed by the second teacher model system 152 may be included in a method which a processor of the second teacher model system 152 may perform. Similarly, operations that are referred to below as being performed by the first specialized machine learning system 180 may be included in a method which a processor of the first specialized machine learning system 180 may perform. Similarly, operations that are referred to below as being performed by the second specialized machine learning system 182 may be included in a method which a processor of the second specialized machine learning system 182 may perform.

Further, at least some operations described as being performed by one system may be performed by a different system.

At an operation 702, the first computing system 130 may receive a data set. The data set may be similar to the type of data set used to train the first specialized machine learning system 180. That is, the data set may be similar to the data set used at the operation 502 of the methods 500, 600 of FIGS. 5 and 6. For example, the data set may be of a similar category as the data set used at the operation 502 of the methods 500, 600 of FIGS. 5 and 6. By way of example, in one implementation, the data set used at the operation 502 may include one or more transcripts of earnings calls and the data set used at the operation 702 may be a transcript of a particular earnings call. Or, in another example, the data set used at the operation 502 may include one or more transcripts of a sporting event broadcast of a particular type and the data set used at the operation 702 may be a transcript of a sporting event broadcast of that same particular type.

The data set may be received, at the operation 702, via a communication module; for example, from another computing system. In some implementations, the data set may be received from memory. In some implementations, the data set may be received from a speech-to-text module that creates a written transcript from audible data.

At an operation 704, the first computing system 130 may perform segmentation on the received data set to generate a number of further data segments. Segmentation at the operation 704 may be performed in the same manner as that described above with reference to the operation 502. For example, segmentation may break the data set, which may represent unstructured and/or text data, into sentences.

At an operation 706, the first computing system 130 may pass the further data segments to the specialized machine learning system to obtain a respective topic for each of the further data segments. That is, the first computing system 130 may pass the further data segments to the first specialized machine learning system 180. The first computing system 130 may pass the further data segments to the first specialized machine learning system 180 iteratively; for example, one at a time.

As noted previously, the first specialized machine learning system 180 may have been previously trained to output a topic that represents an inputted data segment. For example, it may output a topic that represents a sentence that forms the data segment.

The first computing system 130 may, at an operation 708, associate, in a data store, each of the further data segments with its respective topic. That is, the first computing system 130 may associate each of the data segments passed to the machine learning system at the operation 706, with the topic that was output by that machine learning system for that data segment. The first computing system 130 may store each data segment in memory with its associated topic.

Once data segments have been associated with topics, a user interface may be provided at an operation 710. For example, the first computing system 130 may provide the user interface on the client device 140. The user interface may be provided on the client device 140 in response to a request to provide the user interface.

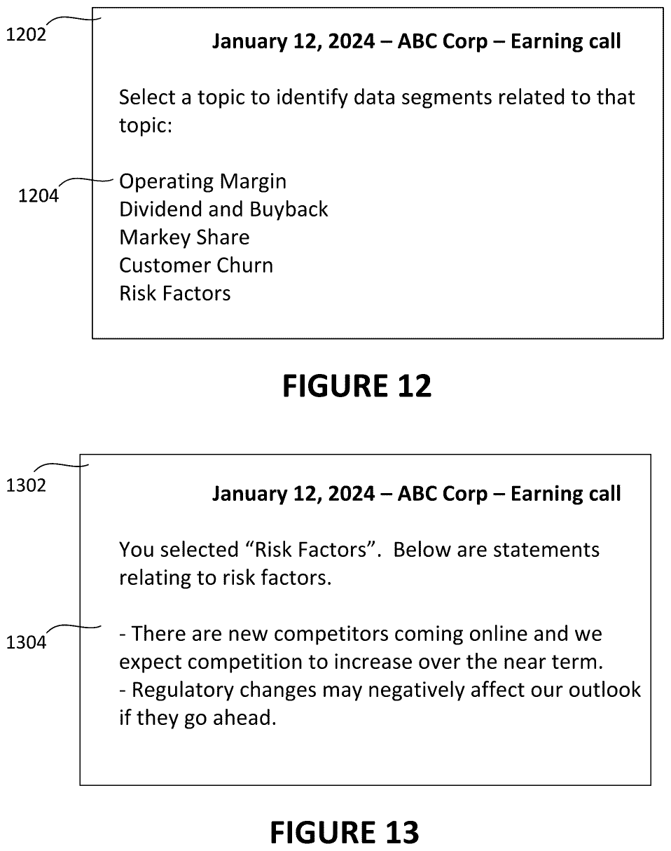

The user interface may be configured for receiving a selection of one or more of the topics of the respective topics. For example, the user interface may list one or more of the topics and each topic in the list may be selectable to cause data segments associated with that topic to be retrieved and output. Referring briefly to FIG. 12, an example user interface screen 1202 of such a user interface is illustrated. The user interface screen 1202 includes a topic listing 1204. The topic listing lists a plurality of topics and each topic is selectable. The user interface may be provided via a communications module or interface.

Referring again to FIG. 7, the first computer system 130 may, at an operation 712, receive a selection of the one or more of the topics of the respective topics. That is, the first computer system 130 may receive an indication of a selection of one of the topics in the topic listing 1204. The indication may be received via the communications module or interface.

At an operation 714, the first computer system 130 may, in response to receiving the selection of the one or more of the topics of the respective topics, retrieve, based on the association of each of the further data segments with its respective topic, one or more of the further data segments having a respective topic corresponding to the one or more selected topics. That is, the first computer system 130 may, based on the topic associations from operation 708, identify the data segments that are associated with the selected topic(s).

The first computer system 130 may then update the user interface at an operation 716. For example, the first computer system 130 may update the user interface to display the identified data segments or a portion thereof. By way of example, the first computer system 130 may list the sentences or other data segments that are associated with the selected topic(s). The first computer system 130 may communicate with the client device 140 to update the user interface if the user interface is provided on the client device 140. Notably, the techniques described herein allow for rapid updating of the user interface. For example, the user interface may be updated in real time despite the large initial data set.

Referring briefly to FIG. 13, an example user interface screen 1302 is illustrated. The example user interface screen may be displayed at the operation 716. The example user interface screen 1302 includes a filtered list 1304 of data segments that are associated with the selected topic(s). For example, the filtered list 1304 may include the data segments retrieved at the operation 714.

As described above, the first computing system 130 may operate to identify one or more topics represented by text data. The first computing system 130 may identify other parameters or indicators associated with text data instead of or in addition to topics. By way of example, in some implementations, the first computing system 130 may be configured to facilitate sentiment analysis. Conveniently, the first computing system 130 may be configured to identify sentiment using a lightweight machine learning system, which may be referred to as a second specialized machine learning system 182. This lightweight machine learning system is configured to use fewer computing resources than a heavyweight machine learning system, such as ChatGPT.

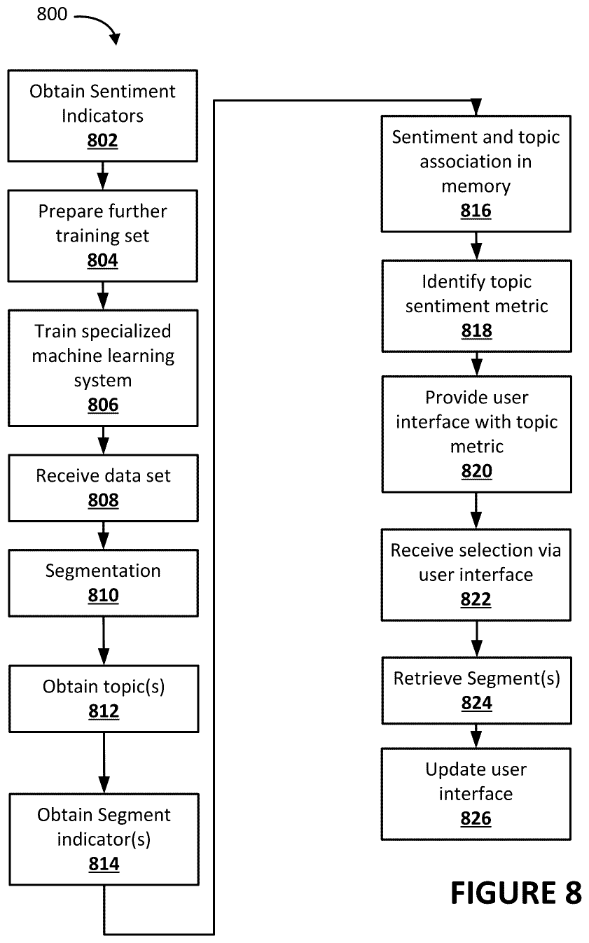

Reference is now made to FIG. 8, which shows, in flowchart form, an example method 800 of training a second specialized machine learning system 182 to identify a sentiment indicated in a data segment. The method 800, in the example, is also a method of using a trained second specialized machine learning system 182 to identify a sentiment indicated in a data segment. While FIG. 8 illustrates an implementation in which the second specialized machine learning system is both trained and used in the method 800, other methods may include only one of these features. For example, a first method may train the second specialized machine learning system 182 and a second method may use the trained second specialized machine learning system 182. The training and the using of the second specialized machine learning system 182 may, in some implementations, be performed by different computing systems.

The method 800, or a portion thereof, may be implemented by a computing system, such as the first computing system 130 (FIGS. 1 and 2). For example, a software module may be configured to cause the first computing system 130 of FIG. 1 to implement the method 800. The method 800 may be performed, for example, by the processor 310 (FIG. 3) of a computer device 300 executing software comprising instructions such as may be stored in the memory 320 of the computer device 300. More particularly, processor-executable instructions may, when executed, configure a processor 310 of a computing system such as the first computing system 130 to perform all or parts of the method 800 or a portion thereof.

In performing the method 800, the first computing system 130 may cooperate with other systems and devices such as, for example, the client device 140, the first teacher model system 150, the second teacher model system 152, the first specialized machine learning system 180 and/or the second specialized machine learning system 182. Each of these devices may be configured with processor-executable instructions which cause such devices to perform methods which cooperate with the method 800. Accordingly, operations that are referred to below as being performed by the client device 140 may be included in a method which a processor of the client device 140 may perform. Similarly, operations that are referred to below as being performed by the first computing system 130 may be included in a method which a processor of the first computing system 130 may perform. Similarly, operations that are referred to below as being performed by the first teacher model system 150 may be included in a method which a processor of the first teacher model system 150 may perform. Similarly, operations that are referred to below as being performed by the second teacher model system 152 may be included in a method which a processor of the second teacher model system 152 may perform. Similarly, operations that are referred to below as being performed by the first specialized machine learning system 180 may be included in a method which a processor of the first specialized machine learning system 180 may perform. Similarly, operations that are referred to below as being performed by the second specialized machine learning system 182 may be included in a method which a processor of the second specialized machine learning system 182 may perform.

Further, at least some operations described as being performed by one system may be performed by a different system.

In at least some implementations, the method 800 may be performed after the first specialized machine learning system 180 has been trained; for example, using the techniques described above with reference to one or more of the methods 500, 600 of FIGS. 5 and 6.

At an operation 802, the first computing system 130 may obtain sentiment indicators for each of a plurality of data segments by providing each of the plurality of data segments to a machine learning system. The data segments are data segments from training data. They may be obtained using the techniques described above with reference to the operation 502 of the methods 500, 600 of FIGS. 5 and 6. For example, the data segments may be sentences obtained from text data of a particular type. For example, the data segments may, in at least one implementation, be extracted from transcripts of past earnings calls.

In at least some implementations, at the operation 802, the first computing system 130 may obtain the sentiment indicators using a second teacher model system 152. In some implementations, the second teacher model system 152 may be the same system as the first teacher model system 150. For example, in one implementation, an LLM system may be used for both the first teacher model system 150 and the second teacher model system 152. For example, one or both of the first and second teacher model systems 150, 152 may be generative pre-trained transformer (GPT) systems. Such systems are resource intensive systems which require significant computing resources to operate.

In systems in which the first teacher model system 150 and the second teacher model system 152 are a common system, the operation 802 may be performed together with the operation 510 of the method 500. That is, the first computing system 130 may obtain both topics and sentiments for the same data segments. By way of example, the first computing system 130 may, in addition to prompting the first teacher model system 150 to generate the topics, also prompt the first teacher model system 150 to generate the sentiments. For example, it may state: “Please also share your view on the sentiment in the inputted sentence, categorizing it as either Negative, Neutral, or Positive. Structure your response in the format: Sentiment: [Negative/Neutral/Positive].” As indicated, the instruction/prompt may include one or more parameters. The parameters may be formatting parameters, in some implementations. The instruction may provide a sentiment indicator set to the teacher model system and the teacher model system may select an appropriate sentiment indicator for each data segment from the set. The sentiment indicator set may include a positive sentiment indicator and a negative sentiment indicator. In at least some implementations, the sentiment indicator set may include a neutral sentiment indicator.

In some implementations, the second teacher model system 152 may be of a different type than the first teacher model system 150. For example, the second teacher model system 152 may be a sentiment analysis model system. By way of example, the second teacher model system 152 may be a finBERT system. FinBERT is a domain-specific natural language processing (NLP) model that leverages the BERT (Bidirectional Encoder Representations from Transformers) architecture to perform financial sentiment analysis. BERT is a transformer-based model that utilizes a bi-directional attention mechanism, allowing it to capture contextual relationships in text more effectively than earlier models.

In some implementations, at the operation 802, multiple teacher model systems may be used. By way of example, in some implementations, FinBERT may be used as a preliminary teacher model, followed by transfer learning from the trained model using the ChatGPT dataset.

Accordingly, at the operation 802, the first computing system may cause the machine learning system, such as the first and/or second teacher model systems 150, 152 to associate each of the plurality of data segments with one of a plurality of sentiment indicators defined in a sentiment indicator set. The first computing system may do so by providing one or more instructions to the machine learning system to cause the machine learning system to perform such operations.

In some implementations, the operation 802 may be performed iteratively. For example, sentiment indicators may be iteratively obtained by providing sentiment indicators to the machine learning system in a sequential manner.

The first computing system 130 may, at an operation 804, prepare a training set for training a sentiment model. This training set may be referred to as a further training set to distinguish from the training set used to train the topic classification model as described above with reference to FIGS. 5 and 6. The further training set may be referred to by various terms including, for example, sentiment training data, a training data set, a sentiment training data set, training data, etc.

The first computing system 130 may prepare the further training data set by associating each of the data segments in the plurality of data segments with one of a plurality of sentiment indicators defined in a sentiment indicator set. That is, the first computing system 130 may create an association in memory between each of the further data segments for which sentiment indicators were obtained at the operation 802 and the sentiment indicator for that data segment.

The first computing system may then, at an operation 806, train a further specialized machine learning system using the further training data set (i.e., the data set obtained at the operation 804). More specifically, the first computing system 130 may train the further specialized machine learning system, such as the second specialized machine learning system 182, using the training data set to configure the further specialized machine learning system to output the one of the plurality of sentiment indicators defined in the sentiment indicator set that best represents a further data segment.

The second specialized machine learning system 182 may be a lightweight machine learning system that has less computing overhead than the first and second teacher model systems 150, 152.

The training of the second specialized machine learning system 182 may be performed similar to the training of the first specialized machine learning system 180. For example, the operation 806 may operate similar to the operation 514 of the method 500 of FIG. 5.

After the second specialized machine learning system 182 has been trained to operate as a sentiment classification system, the second specialized machine learning system 182 may operate as the sentiment classification system. For example, at an operation 808, the first computing system 130 may receive a data set. The data set may, for example, be the same data set received at the operation 702 of the method 700 of FIG. 7, or it may be a similar data set. The data set may be of a similar category to the data set that was used to train the second specialized machine learning system 182. In some implementations, the operation 702 of the method 700 of FIG. 7 and the operation 808 of the method 800 of FIG. 8 may be common operations.

The data set received at the operation 808 may be a transcript of an earnings call in some implementations. Or, in some implementations, it may be a transcript of a live broadcast, such as of a sporting event. The data set may be of other types apart from those specified herein.

At an operation 810, the first computing system 130 may perform segmentation on the received data set to generate a number of further data segments. Segmentation may be performed in the same manner described above with reference to the operation 704 of the method of FIG. 7. In some implementations, the operation 704 of the method 700 of FIG. 7 and the operation 810 of the method 800 of FIG. 8 may be common operations.

After segmentation, topics may be obtained by the first computing system 130 for each of the further data segments at an operation 812. The operation 812 may be performed in the same manner as the operation 706 of the method 700 of FIG. 7. For example, the first computing system 130 may pass the further data segments to the first specialized machine learning system 180 (which may have been previously trained as described above with reference to the methods 500 and 600 of FIGS. 5 and 6) to obtain a respective topic for each of the further data segments.

At an operation 814, the first computing system 130 may obtain segment indicators for each of the further data segments. For example, the first computing system 130 may pass the further data segments to the further specialized machine learning system (i.e., to the second specialized machine learning system 182) to obtain a respective sentiment indicator for each of the further data segments. The sentiment indicator for each of the further data segments are from the sentiment indicator set. For example, the second specialized machine learning system 182 may indicate whether a sentence represented by a given one of the data segments is positive, negative or neutral.

The first computing system 130 may then, at an operation 816, associate, in a data store, such as a memory, each of the further data segments with its respective topic and its respective sentiment indicator. That is, the first computing system 130 may create an association between each of the further data segments and its sentiment indicator and/or topic.

By associating the further data segments with topics and also sentiment indicators, the first computing system 130 effectively creates an association between topics and sentiment indicators that reflect the topic. This allows the first computing system 130 to efficiently determine a per-topic sentiment indicator at an operation 818. For example, the first computing system 130 may identify a sentiment metric for all further data segments in the received data set associated with a particular topic. The sentiment metric may be an average sentiment, for example. By way of example, in one instance, a positive sentiment indicator may be assigned a value of one (1), a negative sentiment indicator may be assigned a value of minus one (−1) and a neutral sentiment indicator may be assigned a value of zero (0). The first computing system 130 may add up all of the numerical values associated with the sentiment indicators for data segments associated with a given topic and then divide by the number of data segments associated with that given topic.

The first computing system 130 may determine the per-topic sentiment indicator for each of the topics represented in the further data segments, or, in some implementations, for the topics that are associated with at least a threshold number of data segments. The first computing system 130 may store the per-topic sentiment indicators in association with each of the respective topics.

At an operation 820, the first computing system 130 may provide a user interface. The user interface may be provided to the client device 140. The user interface may, for example, display the per-topic sentiment indicator for a particular topic. For example, the user interface may display an average sentiment for the particular topic. The user interface may allow for selection of the particular topic. That is, the particular topic may be selectable.

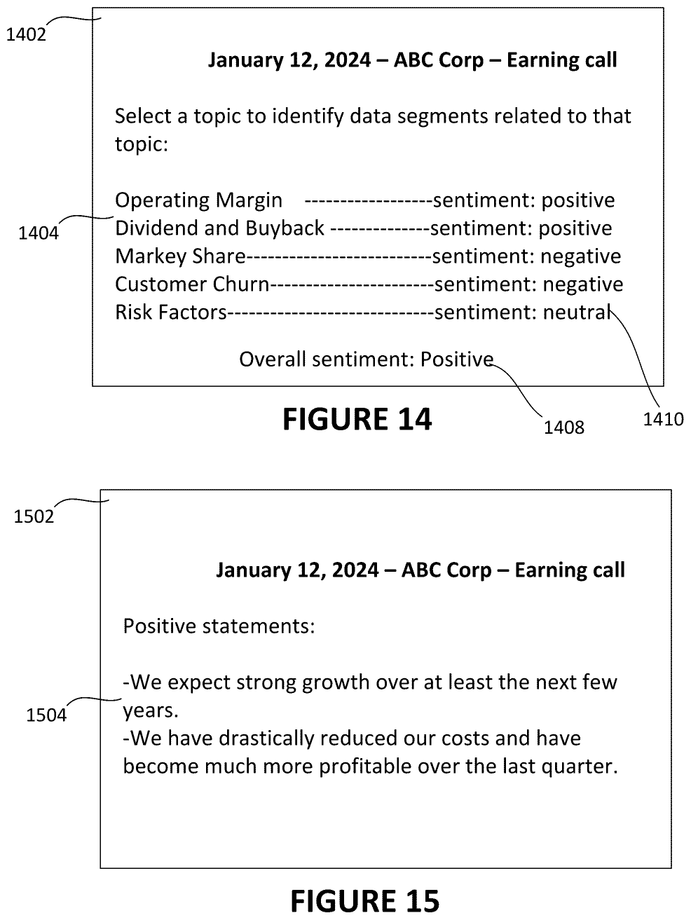

Referring briefly to FIG. 14, an example user interface screen 1402 is illustrated. The example user interface screen includes a topic listing 1404 for a particular data set. For example, the topic listing 1404 may list topics that are identified in the data set received at the operation 808. The topics may be the topics identified at the operation 812.

The user interface screen 1402 includes a per-topic sentiment indicator 1410 for each of the topics. The per-topic sentiment indicator may be the indicator obtained at the operation 818.

In the illustrated example, the user interface screen 1402 includes an overall sentiment indicator 1408. The overall sentiment indicator 1408 indicates a sentiment for the complete data set, such as for a complete earnings call or other data.

The overall sentiment indicator 1408 may be determined by the first computing system 130 using a variety of techniques. For example, in some implementations, the overall sentiment indicator 1408 may be determined as a function of the sentiment indicators for all of the data segments in the data set. For example, it may be determined in a similar manner as the per-topic sentiment indicators, except it may be determined across all topics. In another example, the overall sentiment indicator 1408 may be obtained from the first teacher model system 150 or the second teacher model system 152. Or, it may be that it is obtained from the second specialized machine learning system 182. For example, the full data set may be provided to the second specialized machine learning system 182 to obtain the overall sentiment indicator 1408.

As noted above, the topics displayed in the topic listing 1404 may be selectable. Selectable means that a user interface element allows for input of an indication of selection.

Referring again to FIG. 8, an operation 822, the first computing system 130 may receive an indication of selection of a particular topic. This indication may be received via the user interface; for example, via the user interface screen 1402. The first computing system 130 may receive the indication via a communications module or subsystem which allows for communications with client device 140.

At an operation 824, in response to receiving an indication of selection of the particular topic, the first computing system 130 may retrieve, based on the association of each of the further data segments with the particular topic, one or more of the further data segments having a topic corresponding to the one or more selected particular topic. That is, the first computing system 130 may use the association in memory generated at the operation 816 to identify the data segment(s) that relate to the selected topic.

The first computing system 130 may then, at an operation 826, update the user interface. For example, the first computing system 130 may update the interface on the client device 140. More specifically, the first computing system 130 may update the interface on the client device 140 to display the data segments that are associated with the selected particular topic. That is, the user interface may be updated to display the one or more segments retrieves at the operation 824.

Referring to FIG. 15, an updated user interface will now be described. FIG. 15 illustrates a user interface screen 1502, which may be displayed at the operation 826. The user interface screen 1502 includes a filtered data segment listing 1504. The filtered topic data segment listing 1504 indicates the data segments that are associated with a particular topic in a given data set. More specifically, the filtered topic data segment listing 1504 indicates the data segments that are associated with a selected topic. The filtered topic data segment listing 1504 indicates the data segments retrieved at the operation 824, or a portion thereof (for example a portion that will fit within the screen area of the client device 140).

It will be understood from the discussion above, that the first specialized machine learning system 180 operates as a topic classification machine learning system and the second specialized machine learning system 182 operates as a sentiment classification machine learning system. As described above, this architecture may allow for lightweight classification of both topics and sentiments.

In some implementations, the method 800 of FIG. 7 may be modified. For example, the sentiment analysis operations may, in some implementations, be performed without the topic classification operations also being performed.

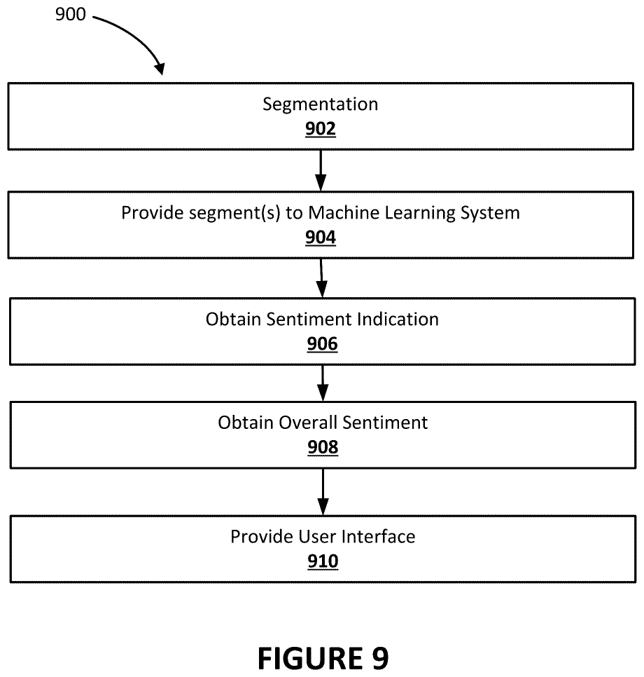

Reference is now made to FIG. 9, which shows, in flowchart form, an example method 900 of providing a user interface that provides for sentiment-based zoom control and/or sentiment-based filtering. The method 900, in the example, is also a method of using a trained second specialized machine learning system 182 to identify a sentiment indicated in a data segment. While FIG. 9 illustrates an implementation in which the second specialized machine learning system is both trained and used in the method 900, other methods may include only one of these features. For example, a first method may train the second specialized machine learning system 182 and a second method may use the trained second specialized machine learning system 182. The training and the using of the second specialized machine learning system 182 may, in some implementations, be performed by different computing systems.

The method 900, or a portion thereof, may be implemented by a computing system, such as the first computing system 130 (FIGS. 1 and 2). For example, a software module may be configured to cause the first computing system 130 of FIG. 1 to implement the method 900. The method 900 may be performed, for example, by the processor 310 (FIG. 3) of a computer device 300 executing software comprising instructions such as may be stored in the memory 320 of the computer device 300. More particularly, processor-executable instructions may, when executed, configure a processor 310 of a computing system such as the first computing system 130 to perform all or parts of the method 900 or a portion thereof.

In performing the method 900, the first computing system 130 may cooperate with other systems and devices such as, for example, the client device 140, the first teacher model system 150, the second teacher model system 152, the first specialized machine learning system 180 and/or the second specialized machine learning system 182. Each of these devices may be configured with processor-executable instructions which cause such devices to perform methods which cooperate with the method 900. Accordingly, operations that are referred to below as being performed by the client device 140 may be included in a method which a processor of the client device 140 may perform. Similarly, operations that are referred to below as being performed by the first computing system 130 may be included in a method which a processor of the first computing system 130 may perform. Similarly, operations that are referred to below as being performed by the first teacher model system 150 may be included in a method which a processor of the first teacher model system 150 may perform. Similarly, operations that are referred to below as being performed by the second teacher model system 152 may be included in a method which a processor of the second teacher model system 152 may perform. Similarly, operations that are referred to below as being performed by the first specialized machine learning system 180 may be included in a method which a processor of the first specialized machine learning system 180 may perform. Similarly, operations that are referred to below as being performed by the second specialized machine learning system 182 may be included in a method which a processor of the second specialized machine learning system 182 may perform.

Further, at least some operations described as being performed by one system may be performed by a different system.

The method 900 may be performed after a specialized machine learning system, such as the second specialized machine learning system 182 has been trained to operate for sentiment classification. The training may be performed as described above with reference to FIG. 8.

At an operation 902, the first computing system 130 may perform segmentation on text data to generate a number of data segments. The operation 902 may be performed as described above with reference to other segmentations; for example, operations 502, 702 and 810. The operation 902 may be performed, for example, to separate the text data into sentences. Each data segment may represent a different one of the sentences. The text data may be unstructured data such as, for example, a transcript. The transcript may be of call, such as an earnings call, or a sporting event broadcast, or a presentation or an event of another type. The text data may be of a similar type of data to the data used to train the second specialized machine learning system 182.

At an operation 904, the first computing system 130 may provide each of the data segments to a machine learning system, such at as the second specialized machine learning system 182. This machine learning system is a system that has been trained to output a sentiment indicator in response to input of a data segment, such as a sentence. The sentiment indicator may be selected from a sentiment indicator set such as, for example, positive, negative and neutral.

At an operation 906, the first computing system 130 may obtain, as output of the machine learning system, an indication of a sentiment associated with each of the data segments obtained during the operation 902. The operations 904 and 906 may, in at least some implementations, be iteratively performed. For example, these operations may be performed for each data segment one data segment at a time until they have been performed for all data segments. The indication of sentiment may be a positive sentiment indicator, a negative sentiment indicator or a neutral sentiment indicator.

At an operation 908, the first computing system 130 may obtain an indication of overall sentiment for a plurality of data segments represented by the text data. In at least some implementations, during the operation 908, the first computing system 130 may obtain an indication of overall sentiment for all of the data segments represented by the text data on which segmentation was performed at the operation 902. For example, it may obtain an overall sentiment for a complete document, such as for a complete transcript.

This operation 908 may be performed in various ways. For example, in one implementation, the first computing system 130 may provide the plurality of data segments represented by the text data to a machine learning system. This machine learning system may be the same machine learning system used to obtain the indication of sentiment for the individual data segments at the operation 906 or it may be a different machine learning system. In some implementations, the machine learning system used at the operation 908 may be a GPT-based machine learning system. The first computing system 130 may obtain, as output of the machine learning system, an indication of a sentiment associated with the plurality of data segments represented by the text data. For example, the first computing system 130 may pass the plurality of data segments to the machine learning system as input and may instruct the machine learning system to generate an overall sentiment indicator reflective of the input.

In some implementations, at the operation 908, the first computing system 130 may obtain the overall sentiment indicator based on a mathematical operation applied to sentiment indicators associated with individual data segments. That is, the overall sentiment indicator may be obtained at the operation 908 based on the sentiment indicators obtained at the operation 906. By way of example, the first computing system 130 may average all of the individual sentiment indicators to obtain the overall sentiment indicator.

The overall sentiment indicator may be of a similar type of indicator as the individual sentiment indicator. However, the overall sentiment indicator is associated with a greater number of data segments than the individual sentiment indicators (obtained at the operation 906). For example, a single overall sentiment indicator may be a complete data set; for example, associated with all data segments obtained at the operation 902. The overall sentiment indicator may indicate one of a positive overall sentiment, a negative overall sentiment, and a neutral overall sentiment. That is, the overall sentiment indicator may be selected from a sentiment indicator set that includes a limited set of sentiment indicators, such as positive, negative and, in some cases, neutral. In some implementations, the sentiment indicator set used for the overall sentiment indicator and/or the individual sentiment indicators may include more than three sentiment indicators. For example, one set might include: very positive, slightly positive, neutral, slightly negative, very negative.

In another example, the indication of overall sentiment obtained at the operation 908 is a summary of an overall sentiment. That is the indication of overall sentiment may not be a single word; it may be a summary, which may be of a predefined maximum length. The summary, which may be referred to as a sentiment summary, may be generated by a machine learning system, such as a GPT-based machine learning system.

In some implementations, the overall sentiment indicator may be associated with a plurality of the data segments represented in the text data from which segmentation was performed at the operation 902, but not all such data segments. For example, in some implementations, the data segments that are used to obtain the overall sentiment are a subset of all of the number of data segments that were obtained through data segmentation. That is, the data segments used to determine the overall sentiment may be a portion of the total data segments obtained at the operation 902. In some instances, as noted previously, a sentiment may be obtained for a filtered listing of data segments, such as segments associated with a particular topic. In some implementations, for computational efficiencies, some of the data segments may be dropped and not used in the operation 908.

After an overall sentiment has been obtained at the operation 908, the first computing system 130 may, at an operation 910, provide the indication of the overall sentiment to a device. For example, the first computing system 130 may provide the indication of the overall sentiment to a client device 140. The indication of overall sentiment may be provided on a user interface. The user interface may identify the text data on which segmentation was performed at the operation 902. The user interface may provide the indication of the overall sentiment together with a selectable option to retrieve one or more of the data segments having an indication of sentiment corresponding to the indication of the overall sentiment.

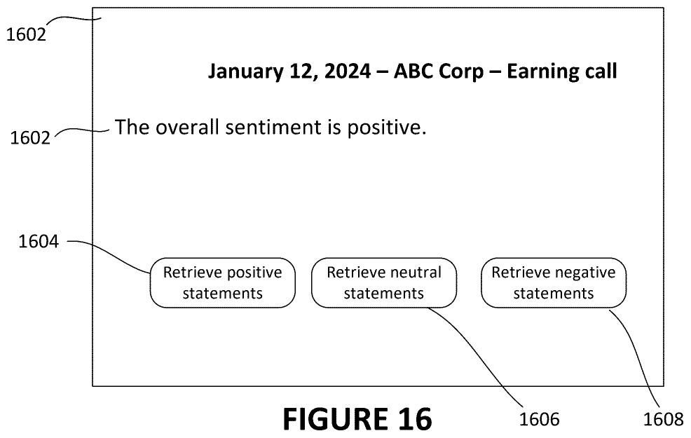

Referring briefly to FIG. 16, an example user interface screen 1602 which may be displayed at the operation 910, is illustrated. The example user interface screen 1602 includes a first selectable option 1604 to retrieve one or more of the data segments having an indication of sentiment corresponding to the indication of overall sentiment. The first selectable option 1604 is an option to retrieve positive data segments; that is, data segments that were associated with a positive sentiment at the operation 906. The example user interface screen 1602 includes a second selectable option 1606. The second selectable option is an option to retrieve data segments associated with a neutral sentiment indicator. The example user interface screen 1602 includes a third selectable option 1608. The third selectable option is an option to retrieve data segments associated with a sentiment indicator that is contrary to the overall sentiment indicator. That is, the third selectable option 1608 may be an option to retrieve data segments that are associated with a sentiment indicator that is opposite the overall sentiment indicator. In the example, the third selectable option 1608 is an option to retrieve negative data segments.

Accordingly, the user interface that is provided at the operation 910 may provide any one or more of: a selectable option, such as the first selectable option 1604, to retrieve one or more of the data segments having an indication of sentiment corresponding to the indication of overall sentiment; a selectable option, such as the second selectable option 1606, to retrieve data segments associated with a neutral sentiment indicator; and a selectable option, such as the third selectable option 1608, to retrieve one or more of the data segments having an indication of sentiment contrary to the indication of the overall sentiment.

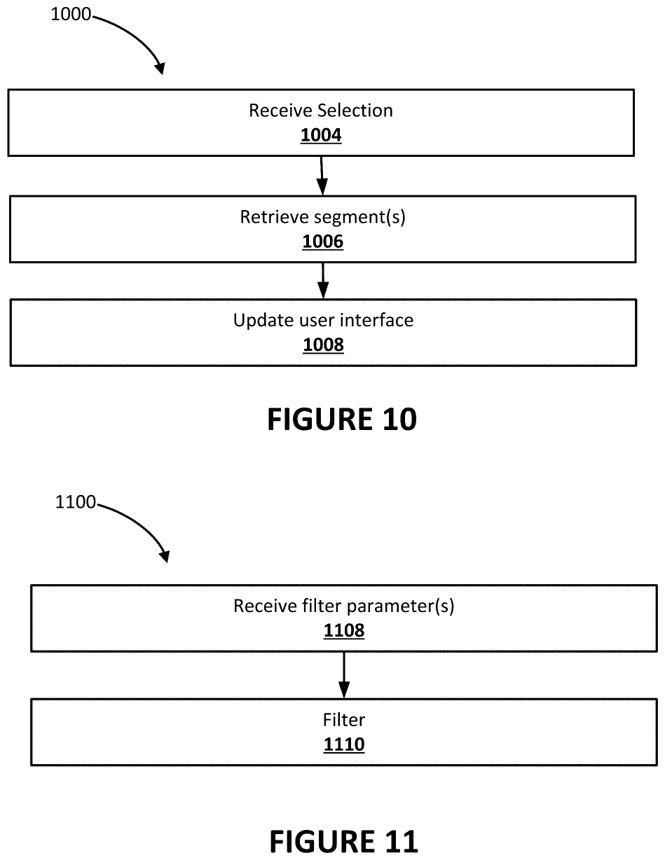

Reference is now made to FIG. 10, which shows, in flowchart form, an example method 1000 of performing sentiment-based zoom control and/or sentiment-based filtering. The method 1000, or a portion thereof, may be implemented by a computing system, such as the first computing system 130 (FIGS. 1 and 2). For example, a software module may be configured to cause the first computing system 130 of FIG. 1 to implement the method 1000. The method 1000 may be performed, for example, by the processor 310 (FIG. 3) of a computer device 300 executing software comprising instructions such as may be stored in the memory 320 of the computer device 300. More particularly, processor-executable instructions may, when executed, configure a processor 310 of a computing system such as the first computing system 130 to perform all or parts of the method 1000 or a portion thereof.

In performing the method 1000, the first computing system 130 may cooperate with other systems and devices such as, for example, the client device 140. Accordingly, operations that are referred to below as being performed by the client device 140 may be included in a method which a processor of the client device 140 may perform. Similarly, operations that are referred to below as being performed by the first computing system 130 may be included in a method which a processor of the first computing system 130 may perform.

Further, at least some operations described as being performed by one system may be performed by a different system.

The method 1000 may be performed after a specialized machine learning system, such as the second specialized machine learning system 182 has been trained to operate for sentiment classification. The training may be performed as described above with reference to FIG. 8. The method 1000 may be performed, for example, after the method 900 of FIG. 9.

At an operation 1004, the first computing system 130 may receive a selection of one of the selectable options on the user interface screen 1602 and/or one of the selectable options provided at operation 910 of the method 900 of FIG. 9. The selection may be received from the client device 140; for example, via a communications interface.

By way of example, the first computing system 130 may receive an indication of selection of the first selectable option 1604; that is, the selectable option to retrieve one or more of the data segments having an indication of sentiment corresponding to the indication of overall sentiment. In another example, the first computing system 130 may receive an indication of selection of the second selectable option 1606; that is, the selectable option to retrieve data segments associated with a neutral sentiment indicator. In another example, the first computing system 130 may receive an indication of selection of the third selectable option 1608; that is, the selectable option to retrieve the one or more of data segments having an indication of sentiment contrary to the indication of the overall sentiment. At the operation 1004, in some implementations, the first computing system 130 may receive sentiment filtering parameters.

At an operation 1006, in response to receiving one of the selections or indications of selections, the first computing system 130 performs a filtering, selection and/or selective retrieval operation. For example, in some implementations, in response to receiving an indication of selection of the first selectable option 1604 (i.e., in response to receiving a selection of the selectable option to retrieve the one or more data segments having the indication of sentiment corresponding to the indication of the overall sentiment), the first computing system 130 may retrieve the data segments having an indication of sentiment corresponding to the indication of the overall sentiment. In another example, the first computing system 130 may, in response to receiving an indication of selection of the second selectable option 1606, retrieve data segments associated with a neutral sentiment indicator. In another example, the first computing system 130 may, in response to receiving an indication of selection of the third selectable option 1608, retrieve the one or more of data segments having an indication of sentiment contrary to the indication of the overall sentiment.

After retrieval, the first computing system 130 may provide one or more of the retrieved data segments to the device, such as the client device 140. For example, the user interface on such a device may be updated, at an operation 1008, to display the one or more of the retrieved data segments.

In some implementations, a system may provide for filtering based on both a topic and a sentiment. An example of one such system will now be described with reference to a method 1100 of FIG. 11.

Reference is now made to FIG. 11, which shows, in flowchart form, an example method 1100 of performing topic-based filtering. The method 1100, or a portion thereof, may be implemented by a computing system, such as the first computing system 130 (FIGS. 1 and 2). For example, a software module may be configured to cause the first computing system 130 of FIG. 1 to implement the method 1100. The method 1100 may be performed, for example, by the processor 310 (FIG. 3) of a computer device 300 executing software comprising instructions such as may be stored in the memory 320 of the computer device 300. More particularly, processor-executable instructions may, when executed, configure a processor 310 of a computing system such as the first computing system 130 to perform all or parts of the method 1100 or a portion thereof.

In performing the method 1100, the first computing system 130 may cooperate with other systems and devices such as, for example, the client device 140. Accordingly, operations that are referred to below as being performed by the client device 140 may be included in a method which a processor of the client device 140 may perform. Similarly, operations that are referred to below as being performed by the first computing system 130 may be included in a method which a processor of the first computing system 130 may perform.

Further, at least some operations described as being performed by one system may be performed by a different system.

The method 1100 may be performed after a specialized machine learning system, such as the second specialized machine learning system 182 has been trained to operate for sentiment classification. The training may be performed as described above with reference to FIG. 8. The method 1000 may be performed, for example, after the method 900 of FIG. 9. The method 1100 may be performed, in some implementations, after the method 1000 of FIG. 10.

As noted above with reference to FIG. 10, one or more retrieved data segments may be provided on a user interface of a device. The data segments may have been retrieved based on a sentiment filtering parameter. For example, the data segments may be retrieved based on a match with a selected sentiment.

The user interface that is displayed, at the operation 1008 of the method 10 of FIG. 10, may include a selectable option to filter the retrieved data segments based on a topic. The first computing system 130 may then, at an operation 1108, receive, via the selectable option to filter the retrieved data segments based on a topic, a filter parameter representing one or more topics. Then, at an operation 1110, the first computing system 130 may, in response to receiving the filter parameter, filter the retrieved data segments based on the filter parameter and update the user interface. For example, only data segments associated with a selected topic(s) may be displayed following the filtering.

The present disclosure relates to computing challenges associated with the storage and analysis of large volumes of data, particularly in the context of processing textual data such as quarterly earnings call transcripts. As organizations generate and collect significant amounts of unstructured data, such as transcripts from earnings calls, the computational resources required to store, process, and analyze these datasets present substantial technical difficulties.

One of the primary computing problems encountered in analyzing large datasets, such as quarterly earnings call transcripts, is the storage requirement. Earnings calls from various companies often consist of lengthy, detailed conversations, sometimes spanning hours. When transcripts from multiple companies and across multiple quarters are aggregated for analysis, the volume of data increases exponentially. Traditional data storage systems may not be adequately optimized to handle the volume of text data, leading to inefficient storage use and high costs. Compression techniques or specialized data formats may be required to mitigate this, but these solutions introduce additional computational overhead for compressing and decompressing data during access. In some implementations, the techniques described above may be used to reduce such storage requirements. For example, a data set may be stored in a manner that removes certain data, such as data segments that are considered neutral.

A significant challenge is the need for efficient data retrieval and indexing. Transcripts from earnings calls typically involve complex and varied language, often covering financial terminology, forward-looking statements, and sector-specific jargon. In order to analyze these transcripts, the data must be indexed effectively to support fast searches, keyword extraction, and contextual understanding. Standard database systems may struggle with indexing such vast and semantically diverse datasets, leading to slow query responses and increased latency, particularly when attempting to perform real-time analysis.

Another computational issue arises during the analysis of the content of the earnings call transcripts. Natural language processing (NLP) algorithms are commonly used to analyze the sentiment, trends, and topics within these transcripts. However, the complexity of financial language, coupled with the volume of transcripts, presents challenges in terms of processing power and memory usage. Analyzing sentiment or extracting relevant financial information from thousands of pages of text requires extensive computational resources, including high-performance processing units and significant memory allocation.

In the context of earnings calls, the transcripts may also contain sections that require more nuanced interpretation, such as identifying shifts in tone or changes in forward-looking guidance. This type of analysis often requires deep learning models, such as transformer-based architectures, to capture the subtle patterns in the text. However, these models are computationally expensive, often requiring powerful GPUs or TPUs, which may not be readily available for large-scale real-time processing. The sheer size of the models, coupled with the size of the datasets, can cause performance bottlenecks, limiting the feasibility of near-instantaneous insights.

Scalability is another significant issue when analyzing large collections of earnings call transcripts. As more data is added over time—new transcripts from future quarters and additional companies—the computational system must be able to scale both storage and processing capabilities. Traditional computing infrastructures often lack the ability to scale elastically, meaning that as the dataset grows, the system may become slower, less efficient, or incapable of handling the increased load. In contrast, cloud-based infrastructures offer more flexible solutions but introduce additional complexities related to data transfer speeds and network latency.

Furthermore, the variability in the structure and content of earnings call transcripts presents additional challenges in automated analysis. Different companies may format their transcripts differently, and the way financial information is conveyed can vary between industries or even between different quarters for the same company. The lack of standardization in how information is presented complicates the task of developing robust algorithms capable of handling these variations, often requiring additional preprocessing steps such as text normalization and cleaning.

Storage and processing challenges are further compounded by the need for real-time or near-real-time analysis of earnings calls, particularly for financial institutions and investors who rely on timely insights to make decisions. Traditional batch processing methods may not be sufficient to meet these demands, and real-time streaming data processing requires both highly optimized algorithms and substantial computational power. As a result, ensuring timely analysis without sacrificing accuracy or context remains a major computational hurdle.

In summary, the computing challenges associated with storing and analyzing large volumes of textual data, such as quarterly earnings call transcripts, span multiple areas, including storage optimization, data indexing, real-time processing capabilities, scalability, and security. The demand for high-performance computing resources, coupled with the need for accurate and timely analysis, creates significant technical obstacles that require advanced computational infrastructure and sophisticated data management strategies.

Conveniently, the systems and methods described herein may address one or more of the computational problems described above. For example, methods and systems are described for enhancing the efficiency of data retrieval, analysis, and storage through the use of advanced generative AI models. Such methods and systems may streamline and optimize the generation of interpretable features from large volumes of data, including but not limited data extracted from quarterly earnings calls or other voluminous data. By implementing a sophisticated training process that leverages knowledge distillation and transfer learning, the system may develop topic and sentiment models that are both efficient and accurate. The techniques described herein may improve computational efficiency, particularly in terms of data retrieval and storage, while facilitating the rapid processing of large datasets.

In at least some implementations, sophisticated generative AI models, such as ChatGPT, may be utilized to create streamlined models that generate easily interpretable features. These features are then used to evaluate large volumes of data, such as financial outcomes from earnings calls. A detailed training approach is described that merges knowledge distillation and transfer learning, resulting in topic and sentiment models.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computer system comprising:
a processor;
a communications module coupled to the processor; and
a memory coupled to the processor, the memory storing instructions that, when executed, configure the processor to:
perform segmentation on text data to generate a number of data segments;
provide each of the data segments to a machine learning system;
obtain, as output of the machine learning system, an indication of a sentiment associated with each of the data segments;
obtain an indication of overall sentiment for a plurality of data segments represented by the text data; and
provide the indication of the overall sentiment to a device, together with a selectable option to retrieve one or more of the data segments having an indication of sentiment corresponding to the indication of the overall sentiment.

2. The computer system of claim 1, wherein obtaining an indication of overall sentiment for the plurality of data segments represented by the text data includes:
providing the plurality of data segments represented by the text data to the machine learning system; and
obtaining, as output of the machine learning system, an indication of a sentiment associated with the plurality of data segments represented by the text data.

3. The computer system of claim 1, wherein the data segments represent sentences.

4. The computer system of claim 1, wherein the instructions further configure the processor to:
receive a selection of the selectable option to retrieve the one or more data segments having the indication of sentiment corresponding to the indication of the overall sentiment;
in response to receiving the selection of the selectable option, retrieving the data segments having an indication of sentiment corresponding to the indication of the overall sentiment; and
providing one or more of the retrieved data segments to the device.

5. The computer system of claim 4, wherein the one or more of the retrieved data segments are provided on a user interface of the device and wherein the user interface includes a selectable option to filter the retrieved data segments based on a topic, and wherein the instructions further configure the processor to:
receive, via the selectable option to filter the retrieved data segments based on a topic, a filter parameter representing one or more topics; and
in response to receiving the filter parameter, filter the retrieved data segments based on the filter parameter and updating the user interface.

6. The computer system of claim 1, wherein the instructions further configure the processor to:
provide at the device, a selectable option to retrieve one or more of the data segments having an indication of sentiment contrary to the indication of the overall sentiment;
receive a selection of the selectable option to retrieve the one or more data segments having the indication of sentiment contrary to the indication of the overall sentiment;
in response to receiving the selection of the selectable option, retrieve the data segments having an indication of sentiment contrary to the indication of the overall sentiment; and
provide one or more of the retrieved data segments to the device.

7. The computer system of claim 1, wherein the text data is a transcript of a call.

8. The computer system of claim 1, wherein the text data is a transcript of a transcript of a presentation.

9. The computer system of claim 1, wherein the indication of overall sentiment indicates one of: a positive overall sentiment, a negative overall sentiment, and a neutral overall sentiment.

10. The computer system of claim 1, wherein the plurality of data segments represented by the text data form all of the text data.

11. The computer system of claim 1, wherein the plurality of data segments represented by the text data are a subset of all of the number of data segments obtained through the segmentation.

12. The computer system of claim 1, wherein the indication of overall sentiment is a summary of an overall sentiment and wherein the summary is a predefined maximum length.

13. A computer-implemented method comprising:
performing segmentation on text data to generate a number of data segments;
providing each of the data segments to a machine learning system;
obtaining, as output of the machine learning system, an indication of a sentiment associated with each of the data segments;
obtaining an indication of overall sentiment for a plurality of data segments represented by the text data; and
providing the indication of the overall sentiment to a device, together with a selectable option to retrieve one or more of the data segments having an indication of sentiment corresponding to the indication of the overall sentiment.

14. The method of claim 13, wherein obtaining an indication of overall sentiment for the plurality of data segments represented by the text data includes:
providing the plurality of data segments represented by the text data to the machine learning system; and
obtaining, as output of the machine learning system, an indication of a sentiment associated with the plurality of data segments represented by the text data.

15. The method of claim 13, wherein the data segments represent sentences.

16. The method of claim 13, further comprising:
receiving a selection of the selectable option to retrieve the one or more data segments having the indication of sentiment corresponding to the indication of the overall sentiment;
in response to receiving the selection of the selectable option, retrieving the data segments having an indication of sentiment corresponding to the indication of the overall sentiment; and
providing one or more of the retrieved data segments to the device.

17. The method of claim 16, wherein the one or more of the retrieved data segments are provided on a user interface of the device and wherein the user interface includes a selectable option to filter the retrieved data segments based on a topic, and wherein the method further includes:
receiving via the selectable option to filter the retrieved data segments based on a topic, a filter parameter representing one or more topics; and
in response to receiving the filter parameter, filtering the retrieved data segments based on the filter parameter and updating the user interface.

18. The method of claim 13, further comprising:
providing at the device, a selectable option to retrieve one or more of the data segments having an indication of sentiment contrary to the indication of the overall sentiment;
receiving a selection of the selectable option to retrieve the one or more data segments having the indication of sentiment contrary to the indication of the overall sentiment;
in response to receiving the selection of the selectable option, retrieving the data segments having an indication of sentiment contrary to the indication of the overall sentiment; and
providing one or more of the retrieved data segments to the device.

19. The method of claim 13, wherein the text data is a transcript of a call.

20. The method of claim 13, wherein the text data is a transcript of a transcript of a presentation.
